(19) United States
(12) Patent Application Publication
(10) Pub. No.: US 2004/0143849 A1
(43) Pub. Date: Jul. 22, 2004

(54) Method and system to create a deterministic traffic profile for isochronous data networks

(76) Inventor: Pierre Costa, Austin, TX (US)

Correspondence Address: Joseph F. Hetz, BRINKS HOFER GILSON & LIONE, P.O. BOX 10395, CHICAGO, IL, 60610, US

(21) Appl. No.: 10/347,135

(22) Filed: Jan. 16, 2003

(51) Int. Cl. H04N 7/173; H04L 12/28; H04L 12/56

(52) U.S. Cl. 725/95; 370/395.43; 370/395.41; 725/87

(57) ABSTRACT

A central office receives on-demand requests from customer premises for selected videos. For each request, a network manager determines a maximum aggregate bit rate of in-progress communications in a network between at least one video server and the central office. The maximum aggregate bit rate is based on associated upper bounds of bit rates for in-progress video downloads. The network manager determines if the network is capable of congestion-free communication of the selected video from the at least one video server to the central office concurrently with the in-progress communications based on a capacity of the network, the maximum aggregate bit rate, and an associated upper bound of bit rate for the selected video.

### CROSS-REFERENCE TO RELATED APPLICATIONS

The present application is related to, and incorporates by reference, the following applications having the same assignee as the present application:

“METHOD AND SYSTEM TO IMPROVE THE TRANSPORT OF COMPRESSED VIDEO DATA IN REAL TIME”, filed on the same day as the present application, having Application No. ______/______, ______ (atty dt. # 8285/590; T00485); and

“VIDEO CONTENT DISTRIBUTION ARCHITECTURE”, filed on the same day as the present application, having Application No. ______/______ (atty dt. # 8285/591; T00490).

The present application also incorporates by reference the entire disclosure of application Ser. No. 09/942,260, filed Aug. 28, 2001, having attorney docket code T00351, now pending.

### BACKGROUND OF THE INVENTION

1. Field of the Invention

The present invention relates to methods and systems for improving the transport of variable bit rate data signals over a bandwidth limited communication network.

2. Description of the Related Art

Numerous compression schemes address the transport and reconstruction of motion images (e.g. video) for pseudo-real-time and non-real-time applications. Many of these schemes make use of buffers, especially at a receiving end of a communication network, for storing partial blocks of information which are pre-transmitted to the receiver. For pseudo-real-time applications, the buffer has a buffer length which is a function of a total amount of bits of information to be sent and a bandwidth available in the communication network. For non-real-time applications, part of the information, such as Discrete Cosine Transform (DCT) coefficients, is sent ahead of time, while the rest of the information is sent later and reconstructed in real time.

The Motion Pictures Experts Group 2 (MPEG2) compression standard makes use of motion compensation to reduce the data rate. Although the content is compressed at a certain bit rate, such as 1.5 Megabits per second (Mbps), the actual bandwidth used temporally varies. The temporal variation creates peaks and troughs in the bandwidth. For purposes of illustration and example, consider a hypothetical real-time transmission of compressed motion images which produces a bit rate versus time graph 10 shown in FIG. 1. The bit rate has an upper bound of 6.5 Mbps and is variable over time. In a DVD movie, for example, the bit rate may vary from 2.5 Mbps to 8 Mbps.

The variable bit rate (VBR) nature of MPEG-based compression introduces challenges in sizing a network to provide digital video services, including video-on-demand (VOD) services. In VOD applications, any of a plurality of customers may attempt to order any of a set of movies at any time. The probabilistic nature of customers ordering videos, in practice, results in a take rate, start time, end time and content that all vary widely. Further, since the video data is VBR, there is a non-zero probability that the bit rate peaks may occur in multiple simultaneously transmitted videos. The probabilistic nature of customer orders along with the varying nature of the bit rate of the video data introduces a possibility that a traffic profile created at one instant of time will create a congested state in the network. The congested state may result in lost cells and ultimately a loss of video data, which produces a poor video quality for the customer.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a graph of bit rate versus time for a hypothetical real-time transmission of compressed motion images;

FIG. 2 is a flow chart of an embodiment of a method of improving the transport of compressed video data;

FIG. 3 illustrates a transmission curve of a VBR representation;

FIG. 4 is an example of four VBR packets within a time window AT;

FIG. 5 is an example of four reformatted packets based on the four VBR packets in FIG. 4;

FIG. 6 is a flow chart of an embodiment of a method performed at a receiver;

FIG. 7 is a block diagram of an embodiment of a system to perform the herein-disclosed methods;

FIG. 8 is a flow chart of an embodiment of a method of communicating multiple video data streams without congestion;

FIG. 9, which is a block diagram of an embodiment of a system to communicate multiple video data streams without congestion; and

FIG. 10 are graphs illustrating how to determine if the network is capable of congestion-free communication for multiple video-on-demand requests.

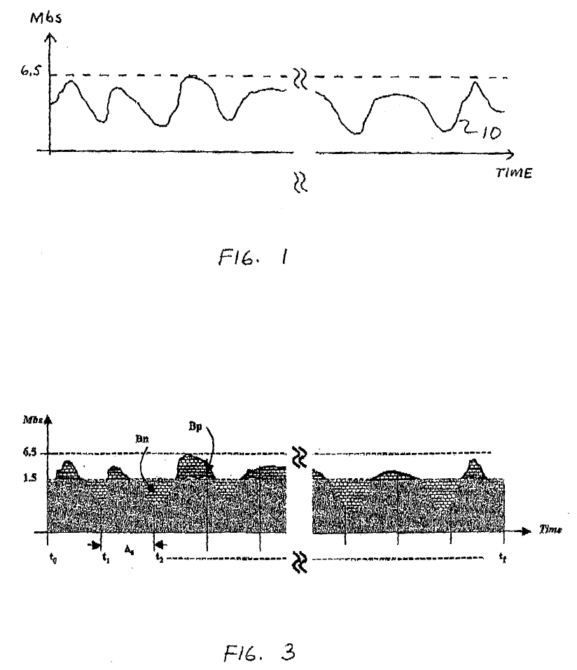

### DETAILED DESCRIPTION OF THE PREFERRED EMBODIMENTS

Disclosed herein are methods and systems that create a deterministic or near-deterministic traffic profile for isochronous data networks, such as those which communicate multiple video data streams. VBR representations of videos are converted into constant bit rate (CBR) or near-CBR representations. An associated upper bound on the bit rate is known for each CBR or near-CBR representation. Since CBR streams with known upper bounds on bit rate are streamed from each server, the network traffic problem becomes deterministic with respect to all in-progress or scheduled video communications. Further, a conditional access step for new VOD orders allows a network operator either to increase the size of the network or to refuse a new VOD order in order to prevent congestion and a resulting poor video quality. Since the traffic characteristics in the network are predictable and congestion occurrences are eliminated, service guarantees can be provided for communicating dynamically time-varying traffic such as video or other isochronous applications.

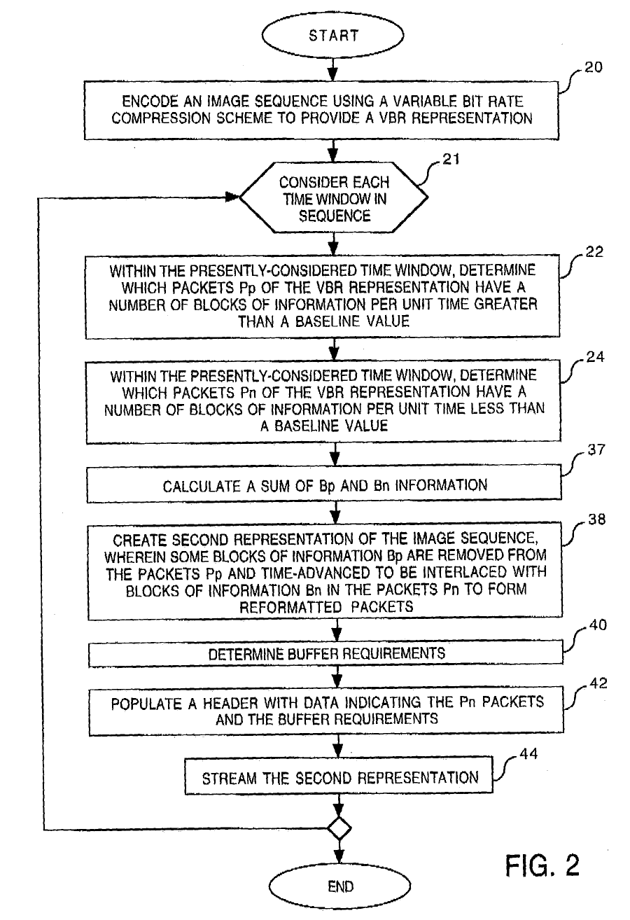

Before describing how to create the deterministic or near-deterministic traffic profile, this disclosure describes (with reference to FIGS. 2 to 7) embodiments of methods and systems for converting VBR representations of videos into CBR or near-CBR representations. The methods and systems can improve, and optionally optimize, the video quality of content on bandwidth-limited transmission links such as satellite links or other wireless links, and Asynchronous Digital Subscriber Line (ADSL) or other DSL links.

Some embodiments for VBR-to-CBR or near-CBR conversion are disclosed in application Ser. No. 09/942,260, filed Aug. 28, 2001, which is incorporated by reference into the present disclosure. In the aforementioned application, a plurality of time intervals Tp and Tn are determined within a VBR representation of an image sequence. The time intervals Tp are those in which a number of blocks of information per unit time is greater than a baseline value. The time intervals Tn are those in which a number of blocks of information per unit time is less than the baseline value. A CBR or near-CBR representation of the image sequence is created in which some blocks of information Bp are removed from the time intervals Tp and interlaced with blocks of information Bn in the time intervals Tn to reduce a variation in a number of blocks of information per unit time between the time intervals Tp and Tn.

Other embodiments, which are described herein, analyze a time window of video content in advance of final coding into a CBR or a near-CBR type data stream. While sending the CBR or near-CBR representation of the time window of video content, another time window of video content may be analyzed to construct its CBR or near-CBR representation. By repeating this process for each time window of video content, a higher quality video delivery results on the same band-limited link.

FIG. 2 is a flow chart of an embodiment of a method of improving the transport of compressed video data. As indicated by block 20, the method comprises encoding an image sequence to provide a VBR representation thereof. The image sequence may be live, such as a live sporting event, a live concert, or another live entertainment event, or a live telephony event such as video conferencing video. Alternatively, the image sequence may be stored, such as a movie, a music video, or educational video, in a storage medium.

The encoding may be based upon a pre-selected peak bit rate which the VBR representation is not to exceed and/or an average bit rate. The image sequence may be encoded in accordance with an MPEG compression standard such as MPEG2, for example. The resulting VBR representation comprises a plurality of packets containing blocks of information.

For purposes of illustration and example, consider the resulting VBR representation having a transmission curve given in FIG. 3. FIG. 3 illustrates the transmission curve in terms of blocks of information that are sent per unit time. The transmission curve can be considered from an energy perspective, wherein the power over a time segment is based on an integral of the transmission curve over the time segment. Further, the instantaneous value varies based on the amplitude of the curve at a point in time. During complex scenes with significant motion, the number of blocks of information is relatively high. In contrast, during periods of little or no motion, the number of blocks of information is relatively low. In this example, the VBR representation has an average bit rate of 1.5 Mbps but an actual link bit rate which varies to 6.5 Mbps.

The VBR representation is segmented into time intervals which start at times t0, t1, t2, . . . , tf. The time intervals define time windows within which the VBR representation is processed to form a CBR or near-CBR representation. Each of the time intervals may have the same duration Δτ, or may have different durations. For example, as described later herein, a time interval having a peak or near-peak bit rate portion of the VBR representation (i.e. one having a complex scene and/or significant motion) may have a greater duration than other time intervals.

Referring back to FIG. 2, each time window is considered in sequence as indicated by block 21. For the presently-considered time window, an analysis of block coding statistics (indicated by blocks 22 and 24) is performed for the VBR representation within the time window. In particular, block 22 indicates an act of determining which packet(s), denoted by Pp, of the VBR representation within the presently-considered time window have a number of blocks of information per unit time greater than a baseline value. Block 24 indicates an act of determining which packet(s), denoted by Pn, of the VBR representation within the presently-considered time window have a number of blocks of information per unit time less than the baseline value.

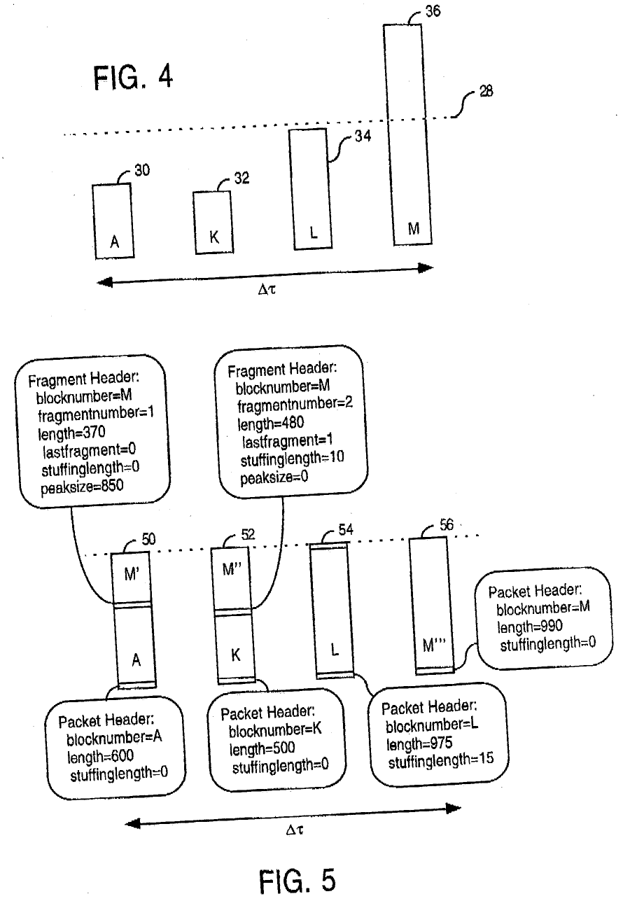

FIG. 4 is an example of four VBR packets within a time window Δτ. The baseline value is indicated by reference numeral 28. The baseline value 28 may be based on an average value for the entire curve in FIG. 3. The baseline value 28 represents the bit rate desired when the transmission rate has been chosen.

Within the time window Δτ, each of the first three packets (indicated by reference numerals 30, 32 and 34) has a number of blocks per unit time that is less than the baseline value 28, and thus are determined to be Pn packets. The last packet (indicated by reference numeral 36) has a number of blocks per unit time that is greater than the baseline value 28, and thus is determined to be a Pp packet.

In the context of this application, the variable Bp represents the equivalent block data that resides above the baseline value in a Pp packet. The variable Bn represents the equivalent block data that resides below the baseline value in a Pn packet. Block 37 in FIG. 2 indicates an act of calculating a sum of Bp and Bn information to ensure that ΣBn>ΣBp for the presently-considered time interval. Optionally, this act may include increasing the duration of the time interval to ensure that ΣBn>ΣBp For example, if ΣBn<ΣBp in a time interval of length Δτ, the time interval may be extended to be 2Δτ, or as many Δτ's needed to ensure that ΣBn>ΣBp. As another option, the time window may have a duration such that ΣBn=ΣBp, which provides an optimal condition for the present invention. Another act that may be performed if ΣBn<ΣBp in the presently-considered time interval is to remove one or more frames from the image sequence so that ΣBn>ΣBp.

An act of creating a second representation of the image sequence is performed as indicated by block 38. In the second representation, some blocks of information Bp are removed from the packets Pp, and time-advanced to be interlaced with blocks of information in the packets Pn to form reformatted packets. The reformatted packets have a reduced variation in a number of blocks of information per unit time from packet-to-packet. Preferably, the time-advanced Bp blocks are distributed into Pn packets so that the number of blocks of information per unit time in the second representation is about equal to the baseline value in all of the reformatted packets in the presently-considered time window. In an exemplary case, the second representation is a CBR representation in which the number of blocks of information per unit time in the second representation is equal to the baseline value in each of the reformatted packets in the presently-considered time window.

The acts described with reference to block 37 ensure that each of the reformatted packets has a size that is within an upper bound, and thus ensure that the CBR or near-CBR representation does not exceed a maximum bit rate.

As indicated by block 40, an act of determining buffer requirements needed at a receiver is performed. The buffer requirements are based on the maximum number of time-advanced blocks that need to be stored in the presently-considered time interval and a small overhead for headers. As indicated by block 42, an act of populating one or more headers in the second representation. The headers may include a packet header for each of the packets, and a fragment header for some or all of the Pn packets.

FIG. 5 is an example of four reformatted packets 50, 52, 54 and 56 based on the four VBR packets 30, 32, 34 and 36 in FIG. 4. Blocks of information are removed from the Pp packet 36 to form the reformatted packet 56. The blocks of information removed from the Pp packet 36 are interlaced with the Pn packets 30 and 32 to form the reformatted packets 50 and 52.

In one embodiment, each reformatted packet comprises all or part of an original VBR packet, and an associated packet header having block number data identifying the original VBR packet, length data indicating the length of the portion of the original VBR packet in the reformatted packet, and optional stuffing length data. Each reformatted packet having time-advanced blocks further comprises an associated fragment header having block number data identifying which original VBR packet is the source of the time-advanced blocks, fragment number data to identify the fragment, length data indicating the length of the time-advanced blocks in the reformatted packet, last fragment number data to indicate a sequence of the fragments, optional stuffing length data, and peak size data indicating how many time-advance bytes need to be buffered to reconstruct the VBR packets.

For example, the reformatted packet 50 comprises all of the original VBR packet 30, and an associated packet header having block number data identifying the original VBR packet 30, length data indicating that the length of the original VBR packet 30 is 600 bytes, and stuffing length data indicating a stuffing length of zero bytes. The reformatted packet 50 also comprises time-advanced blocks from a first portion of the original VBR packet 36, and an associated fragment header having block number data identifying the original VBR packet 36 as the source of the time-advanced blocks, fragment number data to identify this as a first fragment, length data indicating that the length of the time-advanced blocks is 370 bytes, last fragment number data to indicate that this is a first in a sequence of the fragments, stuffing length data indicating a stuffing length of zero, and peak size data indicating that 850 time-advance bytes need to be buffered. The reformatted packet 50 has a size of 1000 bytes (10 bytes in the packet header+600 VBR bytes+20 bytes in the fragment header+370 time-advanced bytes).

The reformatted packet 52 comprises all of the original VBR packet 32, and an associated packet header having block number data identifying the original VBR packet 32, length data indicating that the length of the original VBR packet 32 is 500 bytes, and stuffing length data indicating a stuffing length of zero bytes. The reformatted packet 52 also comprises time-advanced blocks from a second portion of the original VBR packet 36, and an associated fragment header having block number data identifying the original VBR packet 36 as the source of the time-advanced blocks, fragment number data to identify this as a second fragment, length data indicating that the length of the time-advanced blocks is 460 bytes, last fragment number data to indicate that this fragment is subsequent to the first fragment in the reformatted packet 50, stuffing length data indicating a stuffing length of 10 bytes, and peak size data of zero. The reformatted packet 52 has a size of 1000 bytes (10 bytes in the packet header+500 VBR bytes+20 bytes in the fragment header+460 time-advanced bytes+10 stuffing bytes).

The reformatted packet 54 comprises all of the original VBR packet 34, and an associated packet header having block number data identifying the original VBR packet 34, length data indicating that the length of the original VBR packet 34 is 975 bytes, and stuffing length data indicating a stuffing length of 15 bytes. The reformatted packet 54 is absent any time-advanced blocks. The reformatted packet 54 has a size of 1000 bytes (10 bytes in the packet header+975 VBR bytes+15 stuffing bytes).

The reformatted packet 56 comprises a third portion of the original VBR packet 36, and an associated packet header having block number data identifying the original VBR packet 36, length data indicating that the length of the third portion of the original VBR packet 36 is 990 bytes, and stuffing length data indicating a stuffing length of zero bytes. The reformatted packet 56 is absent any time-advanced blocks. The reformatted packet 54 has a size of 1000 bytes (10 bytes in the packet header+990 VBR bytes).

It is noted that the number of bytes assigned to each portion of the reformatted packets in the above example is given for purposes of illustration, and that different numbers of bytes may be used in practice.

As indicated by block 64 in FIG. 2, an act of streaming the second representation of the image sequence via a communication network is performed. Flow of the method returns back to block 21, wherein the next time window of the image sequence is considered to form a second representation. The result of sequentially considering the time windows is a data stream that provides a CBR or near-CBR representation of the image sequence. The resulting stream may be a CBR or near-CBR stream which conforms to the link rate of 1.5 Mbps, but in essence contains coded video at a higher rate, such as 2.0 Mbps for example.

It is noted some sequentially-depicted acts performed in FIG. 2 may be performed concurrently. For example, while streaming the CBR or near-CBR representation of the time window of video content, another time window of video content may be analyzed to construct its CBR or near-CBR representation.

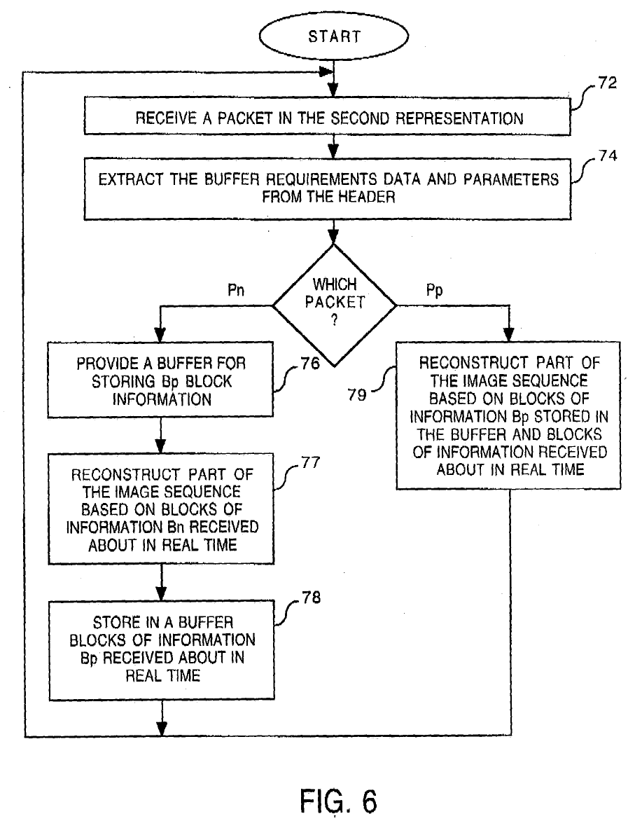

FIG. 6 is a flow chart of an embodiment of a method performed at a receiver. As indicated by block 72, the method comprises receiving one or more packets in second representation of the image sequence via the communication network. As indicated by block 74, the buffer requirement data and other parameters are extracted from the header.

Frames of the image sequence are reconstructed concurrently with the second representation being received. For the packets Pn, a buffer is provided for storing Bp block information based on the buffer requirement data (block 76). Preferably, the buffer comprises a content addressable memory (CAM) type buffer. Further for the packets Pn, frames of the image sequence are reconstructed based on blocks of information received about in real time (block 77). Still further for the packets Pn, the blocks of information Bp which are received are stored in the buffer (block 78). For the packets Pp, frames of the image sequence are reconstructed based on the blocks of information Bp stored in the buffer and blocks of information received about in real time (block 79).

As used herein, the phrase “about in real time” contemplates any processing and/or storage delays which may result in a non-strict real time reconstruction of the frames. Thus, the frames of the image sequence are reconstructed concurrently with the reception of the second representation either strictly in real time or non-strictly in real time.

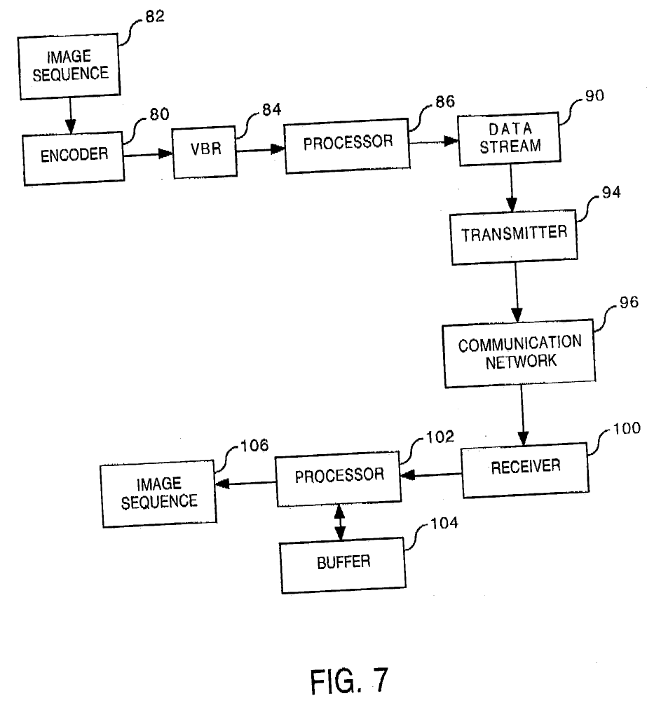

FIG. 7 is a block diagram of an embodiment of a system to perform the herein-disclosed methods. An encoder 80 encodes an image sequence 82 to provide a VBR representation 84. A processor 86 performs the block coding statistics analysis of the VBR representation 84 as described with reference to FIG. 2.

The processor 86 outputs a data stream 90 that contains a representation of the image sequence 82 in which some blocks of information Bp are removed from the packets Pp and time-advanced to be interlaced with blocks of information in the packets Pn to reduce a variation in a number of blocks of information per unit time between the packets Pp and Pn. A transmitter 94 transmits the data stream 90 via a communication network 96.

The system comprises a receiver 100 to receive the data stream 90 via the communication network 96. A processor 102 is responsive to the receiver 100 to reconstruct frames of the image sequence concurrently with the reception of the data stream 90. For the packets Pn, the processor 102 reconstructs frames of the image sequence based on blocks of information received about in real time. Further for the packets Pn, the processor 102 stores the blocks of information Bp in a buffer 104. For the packets Pp, the processor 102 reconstructs frames of the image sequence based on the blocks of information Bp stored in the buffer 104 and blocks of information received about in real time. Reconstructed frames of the image sequence are indicated by reference numeral 106.

The acts performed by the processor 86 may be directed by computer-readable program code stored by a computer-readable medium. Similarly, the acts performed by the processor 102 may be directed by computer-readable program code stored by a computer-readable medium.

The components at the transmitter end may be embodied by a video server, a general purpose personal computer, or a video telephony device, for example. The components at the receiving end may be embodied by a general purpose personal computer, a set-top box, a television receiver, or a video telephony device, for example.

The value of Δτ may be selected with consideration to its resulting delay (which degrades as Δτ increases) and its resulting ability to time-advance all Bp blocks (which improves as Δτ increases). In some applications, Δτ may be selected to be about one or two seconds. In other applications, Δτ may be selected to be from ten to twenty seconds. For two-way video applications, such as two-way video/audio communications, Δτ should be relatively small. Frames can be skipped in time intervals in which the relatively small Δτ results in an inability to time-advance all Bp blocks. For video-on-demand applications, Δτ should be larger to ensure that all Bp blocks can be time-advanced, and thus to ensure that no frames need to be skipped. A locally-held message, such as “your movie is now being downloaded”, and/or an advertisement can be displayed in the period of time needed to process the first Δτ in video-on-demand applications.

It is noted that the herein-disclosed way that packets are segmented, combined with advanced packets, and the packet header format may be applied to embodiments for VBR-to-CBR or near-CBR conversion disclosed in application Ser. No. 09/942,260. With this combination, only a single time window that includes the entire image sequence is processed in accordance with the present application.

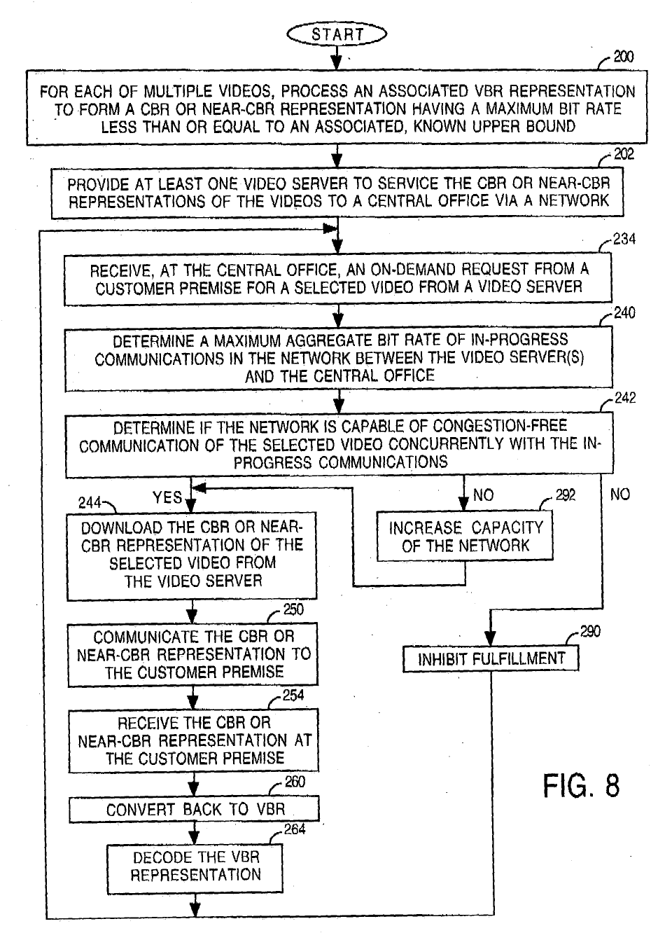

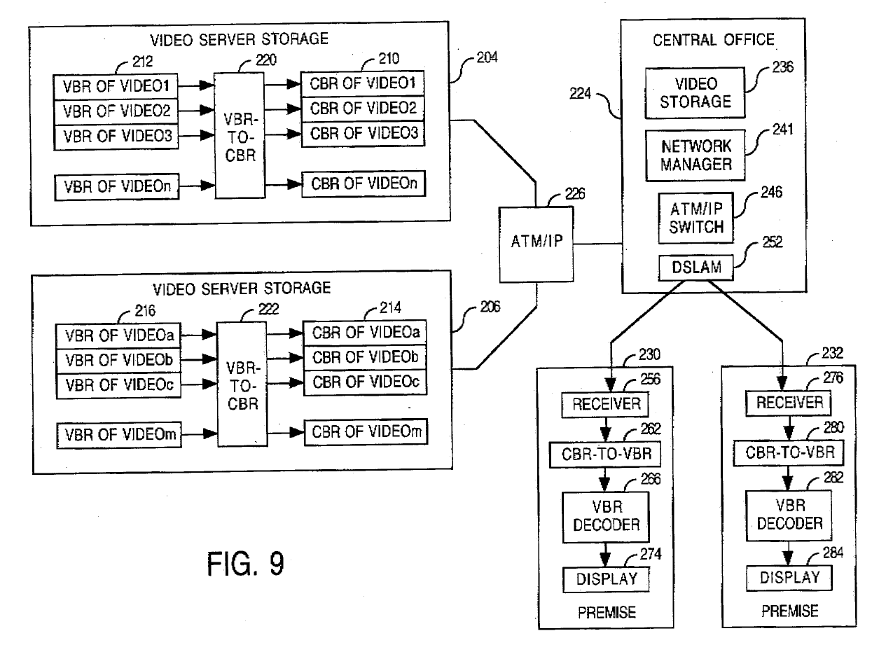

Next, embodiments of methods and systems to create the deterministic or near-deterministic traffic profile are described. The description is made with reference to FIG. 8, which is a flow chart of an embodiment of a method of communicating multiple video data streams without congestion, and FIG. 9, which is a block diagram of an embodiment of a system to communicate multiple video data streams without congestion.

As indicated by block 200, the method comprises processing, for each of a plurality of videos, an associated VBR representation thereof to form an associated second representation having a reduced bit rate variation. The VBR representations may comprise MPEG-based representations of the videos. The MPEG-based representations may be based on any version of MPEG.

Preferably, each second representation is a CBR representation or a near-CBR representation. The second representation may be formed based on the teachings of application Ser. No. 09/942,260 and/or the teachings made in the present disclosure with reference to FIGS. 2 to 7.

Each second representation has a known upper bound on its maximum bit rate. The upper bound may be equal to the maximum bit rate of the second representation over the course of the video, or may be greater than the maximum bit rate. An example of the upper bound being greater than the maximum bit rate is if the maximum bit rate is unknown, but an upper bound on the maximum bit rate is known. The maximum bit rate may be unknown if the VBR-to-CBR or near-CBR conversion is being performed in real-time. For CBR representations, it is preferred that the upper bound simply be the bit rate.

In some embodiments, all of the videos have second representations with about the same upper bound on their bit rates. For example, all of the videos may have CBR representations with the about same bit rate, e.g. about 1.5 Mbps. In other embodiments, some of the videos have second representations with different upper bounds on their bit rates. For example, a first video may have a first upper bound (e.g. 1.5 Mbps) that differs from a second upper bound (e.g. 1 Mbps) for a second video.

As indicated by block 202, the method comprises providing at least one video server to serve the second representation of the videos. Without loss of generality, FIG. 2 illustrates two video servers 204 and 206 (although any number of servers may be used in practice) and CBR representations of the videos (although any bit-rate-variation-reducing second representation including near-CBR representations may be used in practice). The video server 204 is capable of streaming CBR or near-CBR representations 210 of a set of videos 212. The video server 206 is capable of streaming CBR or near-CBR representations 214 of another set of videos 216. The two sets of videos 212 and 216 may have either all videos in common, some videos in common, or no videos in common.

The video server 204 may store either or both of the CBR representations 210 and the VBR representations 212. Similarly, the video server 206 may store either or both of the CBR representations 214 and the VBR representations 216. The video servers 204 and 206 may comprise VBR-to-CBR converters 220 and 222, respectively, to convert the VBR representations to CBR or near-CBR representations.

The video servers 204 and 206 are used to serve the second representation of the videos to a central office 224 via a network 226. In one embodiment, the network 226 comprises an asynchronous transfer mode (ATM) network. In another embodiment, the network 226 comprises an Internet Protocol (IP) network. The video servers 204 and 206 may serve the second representation of the videos to other central offices (not illustrated) in addition to the central office 224. Each of the video servers 204 and 206 may be either located remotely from all other central offices or co-located with a central office other than the central office 224.

The central office 224 serves to provide video data services to multiple customers. Without loss of generality, FIG. 9 shows two customer premises 230 and 232 served by the central office 224, although in practice any number of customer premises may be served by the central office 224.

As indicated by block 234, the method comprises receiving, at the central office 224, an on-demand request from a customer premise 230 or 232 for a selected video. The selected video may be available from the video server 204 and/or the video server 206 and/or video storage 236 at the central office 224. For purposes of illustration and example, consider that the on-demand request is from the customer premise 230 for a selected video available from the video server 204.

As indicated by block 240, the method comprises determining a maximum aggregate bit rate of in-progress communications in the network 226 between the video servers 204 and 206 and the central office 224. This act may be performed by a network manager 241 at the central office 224. The in-progress communications includes CBR or near-CBR transmissions of videos from the video servers 204 and 206 to the central office 224. An example of in-progress communications at the time of the request is the central office 224 receiving a CBR or near-CBR representation of a video from the video server 204 and transmitting the video to the customer premise 232. Since the central office 224 typically serves many customer premises, the in-progress communications will often comprise at least two CBR or near-CBR representations of the videos stored by the video servers 204 and 206.

The maximum aggregate bit rate is based on the associated upper bounds of the CBR or near-CBR videos whose communication is in-progress. In one embodiment, the maximum aggregate bit rate is based on a sum of the associated upper bounds of the CBR or near-CBR videos whose communication is in-progress.

As indicated by block 242, the method comprises determining if the network 226 is capable of congestion-free communication of the selected video from the video server 204 to the central office 224 concurrently with the in-progress communications based on a capacity of the network 226, the maximum aggregate bit rate, and the associated upper bound for the selected video. This act may be performed by the network manager 241 at the central office 224. In one embodiment, the network 226 is determined to be capable of congestion-free communication of the selected video if the sum of the maximum aggregate bit rate and the associated upper bound for the selected video is less than the capacity of the network 226.

If the network is determined to be capable of congestion-free communication of the selected video concurrently with the in-progress communications, the CBR or near-CBR representation of the selected video is downloaded from the video server 204 to the central office 224 via the network 226 (as indicated by block 244). The central office 224 comprises a switch 246 or an alternative element which provides access to the network 226. If the network 226 comprises an ATM network, the switch 246 may comprise an ATM access switch. If the network 226 comprises an IP network, the switch 246 may comprise an IP switch. The CBR or near-CBR representation of the selected video is received by the switch 246.

As indicated by block 250, the CBR or near-CBR representation of the selected video is communicated from the central office 224 to the customer premise 230. If the central office 224 communicates to the customer premise 230 by a digital subscriber line, the central office 224 may comprise a digital subscriber line access multiplexer (DSLAM) 252. The DSLAM 252 directs the CBR or near-CBR representation of the selected video to the customer premise 230.

As indicated by block 254, the CBR or near-CBR representation of the selected video is received by a receiver 256 at the customer premise 230. As indicated by block 260, the CBR or near-CBR representation of the selected video is converted back to the VBR representation (e.g. an MPEG representation) by a converter 262 at the customer premise 230. As indicated by block 264, the VBR representation is decoded by a VBR decoder 266 (e.g. an MPEG decoder) at the customer premise 230. The decoded VBR representation of the selected video is displayed by a display 274 at the customer premise 230. Examples of the display 274 include a television and a computer monitor.

Each customer premise has its own receiver, converter, decoder, and display. For example, the customer premise 232 has a receiver 276, a converter 280, a decoder 282, and a display 284. The components at each customer premise may be embodied by a general purpose personal computer, a set-top box, a television receiver, or a video telephony device, for example.

Referring back to block 242, if the network 226 is determined to be incapable of congestion-free communication of the selected video concurrently with the in-progress communications, the method may comprise inhibiting fulfillment of the video-on-demand request (block 290). Inhibiting fulfillment may comprise either refusing the video-on-demand request or delaying fulfillment until congestion-free communication in the network 226 is ensured. Optionally, the network manager 241 determines a time at which the network 226 will be capable of congestion-free communication of the selected video based on a schedule of in-progress video communications.

Alternatively if the network 226 is determined to be incapable of congestion-free communication of the selected video concurrently with the in-progress communications, an act of increasing the capacity in the network 226 may be performed (block 292). The capacity is increased so that the network 226 is capable of congestion-free communication of the selected video concurrently with the in-progress communications. In this case, bandwidth may be purchased on an as-needed basis. In one embodiment, the capacity is increased to be greater than or equal to the sum of the maximum aggregate bit rate and the associated upper bound for the selected video. After increasing the capacity, the flow of the method is directed to block 244 to download the selected video from a video server, and communicate the selected video to the customer premise.

Acts indicated by blocks 234, 240, 242, 244, 250, 290 and 292 may be directed by the network manager 241. The network manager 241 includes a processor which directs the aforementioned acts based on computer program code. The computer program code includes instructions stored by a computer-usable medium. Examples of the computer-usable medium include, but are not limited to: a magnetic medium such as a hard disk, a floppy disk or a magnetic tape; an optical medium such as an optical disk; and an electronic medium such as an electronic memory or a memory card.

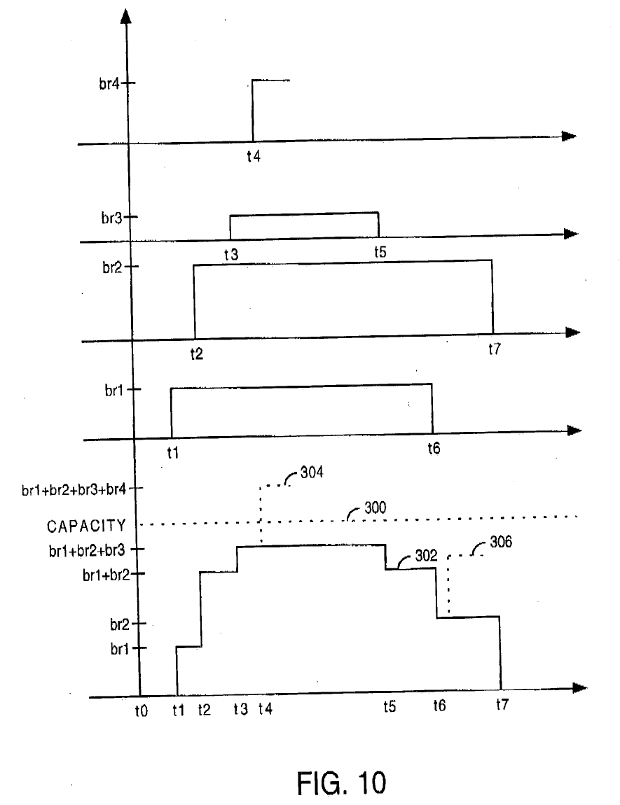

FIG. 10 illustrates how to determine if the network 226 is capable of congestion-free communication for multiple video-on-demand requests. The network 226 has a capacity illustrated by a dotted line 300. The maximum aggregate bit rate of in-progress communications as a function of time is indicated by reference number 302. Between time t0 to t1, no videos are being communicated by the network 226, thus the maximum aggregate bit rate of in-progress communication is zero between time to to t1.

A first VOD request is made for a first video having a substantially constant bit rate br1, a start time t1, and an end time t6. Since the sum of the bit rate br1 and the maximum aggregate bit rate of in-progress communication (being zero) is less than the capacity, the first VOD request is fulfilled.

A second VOD request is made for a second video having a substantially constant bit rate br2, a start time t2, and an end time t7. At the time of the second VOD request, the maximum aggregate bit rate for in-progress communication is br1. Since the sum of the bit rate br2 and the maximum aggregate bit rate of in-progress communication br1 is less than the capacity, the second VOD request is fulfilled.

A third VOD request is made for a third video having a substantially constant bit rate br3, a start time t3, and an end time t5. At the time of the third VOD request, the maximum aggregate bit rate for in-progress communication is (br1+br2). Since the sum of the bit rate br3 and the maximum aggregate bit rate of in-progress communication (br1+br2) is less than the capacity, the third VOD request is fulfilled.

A fourth VOD request is made for a fourth video having a substantially constant bit rate br4 and a start time t4. At the time of the fourth VOD request, the maximum aggregate bit rate for in-progress communication is (br1+br2+br3). Reference numeral 304 indicates what the maximum aggregate bit rate would be if the fourth VOD request were to be fulfilled at the start time t4. Since the sum of the bit rate br4 and the maximum aggregate bit rate of in-progress communication (br1+br2+br3) is greater than the capacity, the fourth VOD request is not fulfilled at the start time t4. Optionally, the network manager 241 may determine that the fourth VOD request may be fulfilled after time t6, at which time the maximum aggregate bit rate of in-progress communication is br2, and where (br2+br4) is less than the capacity of the network 226. Reference numeral 306 indicates what the maximum aggregate bit rate would be if the fourth VOD request were to be fulfilled between the times t6 and t7.

As those having ordinary skill will recognize, the example depicted in FIG. 10 is presented for purposes of illustration and should not be construed as limiting the scope of the present disclosure. Typically, the network 226 is capable of simultaneously communicating many more than three videos. To illustrate a general case, the bit rates br1, br2, br3 and br4 of the videos are all different. However, in practice, many videos will have the same bit rate. For example, some standard-definition videos may have a bit rate of about 1.5 Mbps, and some high-definition videos may have a bit rate of about 12 Mbps.

It will be apparent to those skilled in the art that the disclosed invention may be modified in numerous ways and may assume many embodiments other than the preferred form specifically set out and described above. For example, the teachings herein may be applied non-video data applications.

Accordingly, it is intended by the appended claims to cover all modifications of the invention which fall within the true spirit and scope of the invention.

What is claimed is:

1. A method comprising:
for each of a plurality of videos, processing an associated variable bit rate (VBR) representation thereof to form an associated second representation having a reduced bit rate variation and a maximum bit rate less than or equal to an associated, known upper bound;
providing at least one video server to serve the second representation of the videos to a central office via a network;
receiving, at the central office, an on-demand request from a customer premise for a selected video from the at least one video server;
determining a maximum aggregate bit rate of in-progress communications in the network between the at least one video server and the central office, wherein the in-progress communications comprises at least two of the videos, and wherein the maximum aggregate bit rate is based on the associated upper bounds of the at least two of the videos; and
determining if the network is capable of congestion-free communication of the selected video from the at least one video server to the central office concurrently with the in-progress communications based on a capacity of the network, the maximum aggregate bit rate, and the associated upper bound for the selected video.

2. The method of claim 1 further comprising:
if the network is determined to be capable of congestion-free communication of the selected video concurrently with the in-progress communications:
downloading the second representation of the selected video from the at least one video server to the central office via the network; and
communicating the second representation of the selected video from the central office to the customer premise.

3. The method of claim 2 further comprising:
receiving the second representation at the customer premise;
converting the second representation back to the VBR representation at the customer premise; and
decoding the VBR representation to extract the video at the customer premise.

4. The method of claim 1 further comprising:
inhibiting fulfillment of the video-on-demand request if the network is determined to be incapable of congestion-free communication of the selected video concurrently with the in-progress communications.

5. The method of claim 1 further comprising:
if the network is determined to be incapable of congestion-free communication of the selected video concurrently with the in-progress communications:
increasing the capacity in the network so that the network is capable of congestion-free communication of the selected video;
downloading the second representation of the selected video from the at least one video server to the central office via the network; and
communicating the second representation of the selected video from the central office to the customer premise.

6. The method of claim 1 wherein the VBR representation of the selected video comprises an MPEG-based representation of the selected video.

7. The method of claim 1 wherein the second representation of the selected video comprises a constant bit rate representation.

8. The method of claim 1 wherein the second representation of each of the plurality of videos comprises an associated constant bit rate representation.

9. The method of claim 1 wherein the at least two of the videos comprise a first video and a second video, wherein the associated upper bound for the first video differs from the associated upper bound for the second video.

10. The method of claim 1 wherein the network comprises at least one of an asynchronous transfer mode (ATM) network and an Internet Protocol (IP) network.

11. A system comprising:
a processor to process, for each of a plurality of videos, an associated variable bit rate (VBR) representation thereof to form an associated second representation having a reduced bit rate variation and a maximum bit rate less than or equal to an associated, known upper bound;
at least one video server to serve the second representation of the videos via a network;
a central office to receive an on-demand request from a customer premise for a selected video from the at least one video server, the central office having a network manager to:
determine a maximum aggregate bit rate of in-progress communications in the network between the at least one video server and the central office, wherein the in-progress communications comprises at least two of the videos, and wherein the maximum aggregate bit rate is based on the associated upper bounds of the at least two of the videos; and
determine if the network is capable of congestion-free communication of the selected video from the at least one video server to the central office concurrently with the in-progress communications based on a capacity of the network, the maximum aggregate bit rate, and the associated upper bound for the selected video.

12. The system of claim 11 wherein if the network manager determines that the network is capable of congestion-free communication of the selected video concurrently with the in-progress communications, the central office is to:
download the second representation of the selected video from the at least one video server via the network; and
communicate the second representation of the selected video to the customer premise.

13. The system of claim 12 further comprising:
a receiver to receive the second representation at the customer premise;
a converter to convert the second representation back to the VBR representation at the customer premise; and
a decoder to decode the VBR representation to extract the video at the customer premise.

14. The system of claim 11 wherein the network manager is to inhibit fulfillment of the video-on-demand request if the network is determined to be incapable of congestion-free communication of the selected video concurrently with the in-progress communications.

15. The system of claim 11 wherein if the network manager determines that the network is incapable of congestion-free communication of the selected video concurrently with the in-progress communications, the central office is to:
increase the capacity in the network so that the network is capable of congestion-free communication of the selected video;
download the second representation of the selected video from the at least one video server via the network; and
communicate the second representation of the selected video to the customer premise.

16. The system of claim 11 wherein the VBR representation of the selected video comprises an MPEG-based representation of the selected video.

17. The system of claim 11 wherein the second representation of the selected video comprises a constant bit rate representation.

18. The system of claim 11 wherein the second representation of each of the plurality of videos comprises an associated constant bit rate representation.

19. The system of claim 11 wherein the at least two of the videos comprise a first video and a second video, wherein the associated upper bound for the first video differs from the associated upper bound for the second video.

20. The system of claim 11 wherein the network comprises at least one of an asynchronous transfer mode (ATM) network and an Internet Protocol (IP) network.
